(19) United States
(12) Patent Application Publication
(10) Pub. No.: US 2016/0203315 A1
(43) Pub. Date: Jul. 14, 2016

(54) SYSTEM AND METHOD FOR GRANTING ACCESS TO SECURED ENVIRONMENTS

(71) Applicant: EVERYKEY INC, Cleveland, OH (US)

(72) Inventors: Christopher WENTZ, Longmont, CO (US); Thomas J. EMELKO, Concord, OH (US); Kyle HARRITY, Lakewood, OH (US); Ruslan BEREZYUK, Buenos Aires (AR)

(21) Appl. No.: 15/078,237

(22) Filed: Mar. 23, 2016

Related U.S. Application Data
(63) Continuation-in-part of application No. 14/333,598, filed on Jul. 17, 2014.
(60) Provisional application No. 61/929,845, filed on Jan. 21, 2014.

(51) Int. Cl. G06F 21/53; G06F 21/88; G06F 21/62; H04L 29/06

(52) U.S. Cl. CPC G06F 21/53; H04L 63/10; G06F 21/88; G06F 21/62; H04L 63/1408; G06F 2221/2149

(57) ABSTRACT

A controlled access device includes at least one processor, at least one computer readable medium, and program instructions stored on the at least one computer readable medium for execution by the processor. The program instructions include: first program instructions to continuously listen for advertisement data being broadcast by a lock device, the advertisement data indicative of the lock device being within a predefined range of the controlled access device; second program instructions to automatically retrieve a key for granting access to the controlled access device responsive to the first program instructions detecting the advertisement data while the controlled access device is in a locked state; third program instructions to unlock the controlled access device and grant access to the controlled access device responsive to the second program instructions retrieving the key; and fourth program instructions to lock the controlled access device.

### CROSS-REFERENCE TO RELATED APPLICATIONS

This application is a continuation-in-part of U.S. application Ser. No. 14/333,598 filed on Jul. 17, 2014, which claims priority to U.S. Provisional Patent Application Ser. No. 61/929,845 filed on Jan. 21, 2014, both of which are incorporated by reference in its entirety as is fully set forth herein.

### FIELD OF INVENTION

The present disclosure relates to the field of access control. More particularly, the present disclosure relates to a system and method for granting access to secured environments.

### BACKGROUND

Access to computer software, hardware, and other devices, both electrical and mechanical, is commonly controlled using passwords or other types of digital. or mechanical keys. A smartphone, for example, may require a passcode or password to be input before it can be unlocked and used to make a call. Similarly, a computer may require a password to be input before it can be used for various computing functions. Software, such as a banking application, may require a password to be input before the application may be used to perform banking tasks. And a door may require a physical key to be inserted before the door can be unlocked and opened.

Remembering passwords and passcodes, however, may be cumbersome and impractical, particularly when a user may be required to keep track of multiple passwords that correspond to gaining access to a variety of software applications, devices, doors, and so on. In addition, storing physical keys for gaining access to a variety of doors, devices, and so on, may be cumbersome and impractical as well.

### SUMMARY

A controlled access device includes at least one processor, at least one computer-readable medium, and program instructions stored on the at least one computer-readable medium for execution by the processor. The program instructions include: first, program instructions to continuously listen fur advertisement data being broadcast by a lock device, the advertisement data indicative of the lock device being within a predefined range of the controlled access device; second, program instructions to automatically retrieve a key for granting access to the controlled access device responsive to the first program instructions detecting the advertisement data while the controlled access device is in a locked state; third, program instructions to unlock the controlled access device and grant access to the controlled access device responsive to the second program instructions retrieving the key; and fourth, program instructions to lock the controlled access device.

An access control method includes the step of listening for advertisement data being broadcast by a lock device, the advertisement data indicative of the lock device being within a predefined range of a controlled access device. The method further includes the step of automatically retrieving a key for granting access to the controlled access device responsive to detecting the advertisement data while the controlled access device is in a locked state. The method further includes the step of unlocking the controlled access device and granting access to the controlled access device responsive to retrieving the key. The method further includes the step of locking the controlled access device and denying access to the controlled access device responsive to ceasing to detect the advertisement data while the controlled access device is an unlocked state.

An access server for controlling simultaneous access to a plurality of controlled access devices via a paired lock device includes at least one processor, at least one computer readable medium, and program instructions stored on the at least one computer-readable medium for execution by the processor. The program instructions include first program instructions to receive, from a plurality of controlled access devices, requests for keys for unlocking the respective plurality of controlled access devices responsive to the plurality of controlled access devices detecting an advertisement being broadcast by the lock device indicative of the lock device being within a predefined range of the plurality of controlled access devices. The program instructions further include second program instructions to communicate keys to the respective controlled access devices responsive to determining that the respective controlled access devices have been paired with the lock device.

### BRIEF DESCRIPTION OF DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example key device and a controlled access device.

FIG. 2 illustrates an example key device and a controlled access device.

FIG. 3 is a block diagram illustrating exemplary components of a controlled access device of FIG. 1.

FIG. 4 illustrates an example key device and a controlled access device.

FIG. 5 is a flow diagram illustrating exemplary interaction between a controlled access device, a key device, and an access server.

FIG. 6 is a block diagram illustrating exemplary components of an embodiment of a key device of FIG. 1.

FIG. 7 is a flow diagram illustrating exemplary interactions between a key device and a controlled access device.

FIG. 8 is a flow diagram illustrating exemplary interactions between a key device and a controlled access device.

FIG. 9 is a flow diagram illustrating exemplary interactions between a key device and a controlled access device.

### DETAILED DESCRIPTION

A user authentication device and method is disclosed. In one embodiment, a universal access device (henceforth referred to as “key device”) is configured to provide access to computer hardware, computer software, and other electrical and mechanical devices that requires a virtual or physical key or password. The key device may include a wireless communications enabled device that the user wears, possesses, or otherwise maintains in physical proximity to allow for access to a suitably configured. smartphone, tablet, computer, and devices not normally thought of as having logic such as a door, car door, bike lock, and other controlled access devices. It should he appreciated that controlled access devices such as doors that are not normally thought of as having logic may need to be outfitted with a device including logic in order to communicate with the key device. When the key device is within. range of one of the user's controlled access devices, the key device will allow the user to bypass that controlled access devices password or physically unlock it, eliminating the need for complicated passwords and cumbersome keys. When the key device is moved out of range, the controlled access device may re-enable its security mechanisms, so it is safe and secure when out of the user's hands.

In another embodiment, the key device may communicate with controllers in a user environment such as a room in a house, an office, or a vehicle to establish user environmental preferences such as temperature, lighting, music, video and the like. When a user departs the area or after a delay, the controllers may revert to default preferences such as turning off lights and otherwise adjusting environmental controls for energy efficiency.

In operation, the key device and the controlled access device do not require two-way communication and authentication protocols provided that the devices have been initialized and maintain relatively close clock synchronization.

The following description includes definitions of selected terms used throughout the disclosure. Both singular and plural forms of all terms fall within each meaning.

“Address” as used herein includes, but is not limited to, one or more network. accessible addresses, device identifiers, telephone numbers, IP addresses, URL and ftp locations, e-mail addresses, names, a distribution list including one or more addresses, network drive locations, postal addresses, account numbers or other types of addresses that can identify a desired destination or device.

“Computer-readable medium” as used herein refers to any medium that participates directly or indirectly in providing instructions and/or data to one or more processors for execution. Such a medium may take many forms, including but not limited to, non-volatile media, and volatile media. Non-volatile media may include, for example, optical or magnetic disks. Volatile media may include, for example, dynamic memory. Common forms of computer-readable media include, for example, a floppy disk, a flexible disk, hard disk, magnetic tape, any other magnetic medium, a CD-ROM, any other optical medium, punch cards, paper tape, any other physical medium with patterns of holes, a RAM, a PROM, an EPROM, a FLASH-EPROM, any other memory chip or cartridge, or any other medium which can be read by a computer, a processor or other electronic device.

“Logic” as used herein includes, but is not limited to, hardware, firmware, software and/or combinations of each to perform a function(s) or an action(s), and/or to cause a function or action from another component. For example, based on a desired application or needs, logic may include a software controlled microprocessor, discrete logic such as an application specific integrated circuit (ASIC), a programmed. logic device, memory device containing instructions, or the like.

“Signal” as used herein includes, but is not limited to, one or more electrical or optical signals, analog or digital signals, one or more computer or processor instructions, messages, a bit or bit stream, or other means that can be received, transmitted, and/or detected.

“Software” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system, or other type of executable instructions, it will be appreciated by one of ordinary skill in the art that the form of software is dependent on for example, requirements of a desired application, the environment it runs on, and/or the desires of a designer/programmer or the like.

“User” as used herein includes, but is not limited to, one or more persons, software components, computers, or other devices capable of using or accessing a component or combinations of these.

Generally speaking, one embodiment of a system and method as used herein includes, but is not limited to, a user-associated key device that communicates with and provides access to a controlled access device having some form of access control such as password, key and the like. When in wireless communication and the key device and controlled access device successfully communicate, the controlled access device is at least temporarily accessible without the user having to manually engage with the access control apparatus.

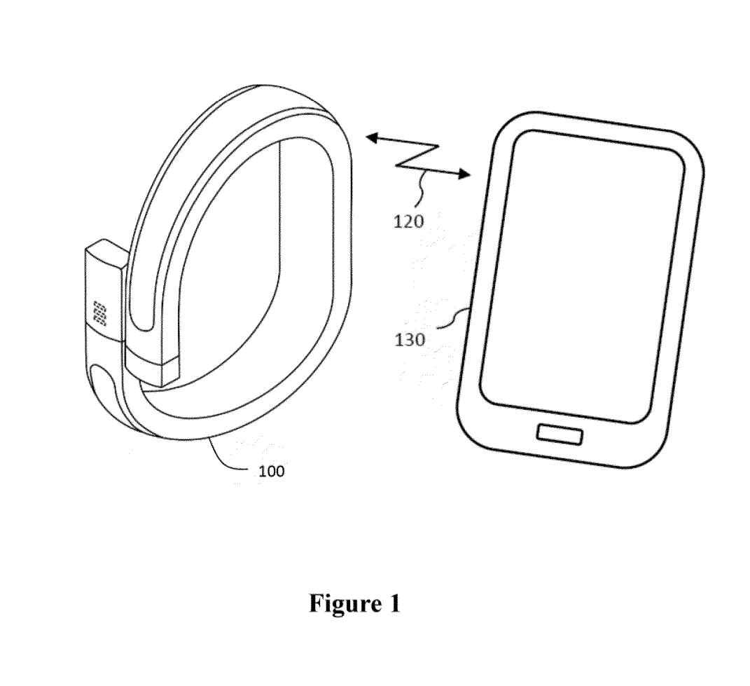

With reference to FIG. 1, an exemplary key device 100 is formed from any suitable material and is shaped to be worn on the wrist of a user (not shown). In other embodiments, the key device 100 may take the form of a wristband, finger ring/toe ring, ear ring/ear stud, necklace, credit card sized wallet insert/purse insert, eyeglasses, epidermal implant, tattoo, other accessory, smartphone, key fob, key chain, sticker, pen, or pencil. The key device 100 communicates 120, preferably via wireless communication such as radio-frequency, infra-red, WiFi, Bluetooth, RFID or Near Field Communication, with a controlled access device 130 such as the smartphone illustrated, and grams access to controlled access device 130. In other embodiments, controlled access devices may alternatively or additionally include but are not limited to a tablet device, a laptop computer/desktop computer, house door/apartment door/office door/hotel room door, car door, bike lock, payment terminal, padlock, safe, locking drawer/locking cabinet, firearm, light, television, heating/air conditioning unit, garage door, sink, shower, ATM, music player, printer, public storage rental unit, personal identification system, or controllers for other devices.

In order to grant access to the controlled access device 130, the key device 100 advertises an encrypted “I'm here” message. it should be appreciated that the “I'm here” message can be any suitable type of notice or communication being broadcast by the key device 100 in order to indicate the presence of the key device 100. Upon receiving and decrypting the advertisement from a valid key device 100, the controlled access device 130 retrieves an encrypted stored unlocking key or password for the controlled access device 130, decrypts the password, and changes to “key in range” and “unlocked” states to allow access.

In one example, the controlled access device 130 may track two different statuses or states. For example, the controlled access device 130 may separately keep track of whether the key device 100 is within range and whether the controlled. access device is locked or unlocked. For example, the encrypted stored password may be retrieved and decrypted upon receiving a request to unlock the controlled access device 130, in particular, a controlled access device 130 may include an interface such as a button for initiating an unlock procedure which could he configured to trigger a request for a. password. Thus, the request may be bypassed and the controlled access device 130 may automatically retrieve a password and enable access upon the button being interfaced. Accordingly, the state of controlled access device 130 may be defined as “Key in range” but still “locked” while the password is being retrieved or before the button interface is engaged. Once the button interface is engaged, the password is retrieved, and the controlled access device 130 is successfully unlocked, the controlled access device 130 switches states to “key in range” and “unlocked.” In one example, the controlled access device 130 may be configured to automatically retrieve the password and enable access as soon as the advertisement is received, thereby bypassing the need for the button being interfaced. Accordingly, the state of controlled access device 130 may be defined as “Key in range” and “unlocked” as soon as the key device 130 is within range.

Once the password is retrieved and the controlled access device 130 is unlocked, the controlled access device 430 maintains an “unlocked” state as long as it continues to detect the advertisements being broadcast by the key device 100. If, however, the controlled access device 130 stops detecting advertisements, the controlled access device 130 switches to “no key in range” state, automatically locks the controlled access device 130, and switches to a “locked” state, thereby preventing access.

In one example, the controlled access device 130 locally encrypts and stores a password for unlocking the controlled access device 130. In such an example, no Internet connection is required to retrieve a password and grant access. In another example, a password required to unlock the controlled access device 130 may be stored at a remote location. in such an example, an Internet connection may be required to retrieve the password and unlock the controlled access device 130.

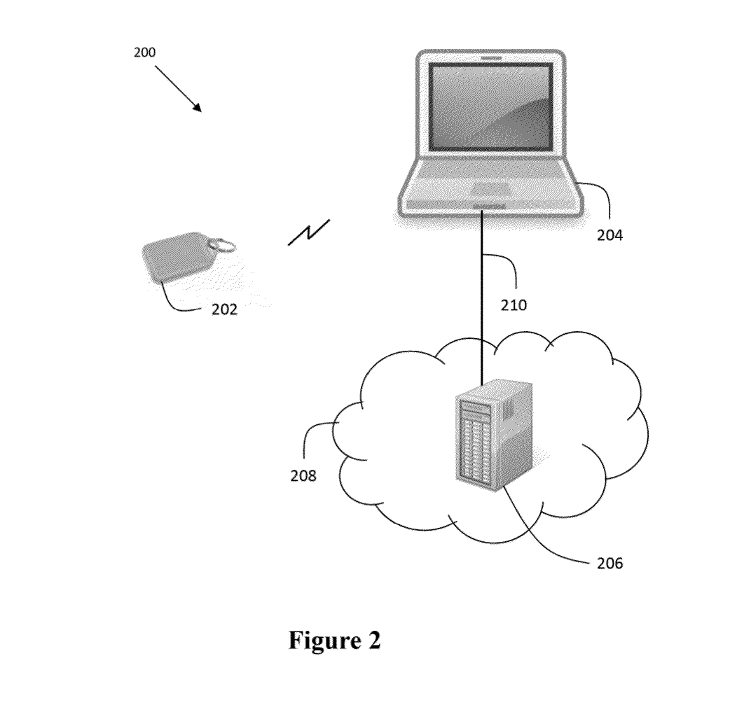

FIG. 2 illustrates an example system 200 for enabling a key device 202 to unlock the controlled access device 204 by retrieving a remotely stored password. It should be appreciated that although the example key device 202 is depicted as a key fob, the key device 202 may include any suitable form as described. It should further be appreciated that although the controlled access device 204 is depicted as a laptop computer, the controlled access device 204 may include any suitable device as described. In addition, controlled access device 204 may include password-protected software or password-protected websites. Although retrieving a password from a remote location may require an Internet connection, remotely storing the password may also increase security and further prevent unauthorized access to the secured access device 204. In addition, storing the password remotely may improve the extensibility and flexibility of the system 200 since the remotely stored passwords may be retrieved by numerous clients, instead of only being made available to a single client as is the case for a locally stored password. In particular, a remotely stored website password may facilitate access to the website from any computing device that detects an “I'm here” advertisement from a key device 202.

System 200 includes an access server 206 in a cloud environment 208 in communication with the controlled access device 204. it should be appreciated that although access server 206 is illustrated as communicating with the controlled access device 204 via a wired connection 210, access server 206 may similarly communicate with the controlled access device 204 wirelessly. In one example, the controlled access device 204 communicates with the access server 206 using WebSocket protocol.

In one example, the access server 206 encrypts and stores a password defined by a user of the key device 202 and associates the password with the key device 202 and the controlled access device 204, in one example, the controlled access device 204 encrypts the password and communicates the password to the access server 206 for storage. Accordingly, when the key device 202 is within range of the controlled access device 204 and the controlled access device 204 receives advertisements from the key device 202 indicating that the key device 202 is within range, the controlled access device 204 communicates with the access server 206 to request a password necessary for accessing the controlled access device 204. If access server 206 identifies a stored password associated with the key device 202 and the controlled access device 204, the access server 206 communicates the password to the controlled access device 204 in order to grant access. Otherwise, the access server 206 may reject the request and inform the controlled access device 204 that access should not be granted.

It should be appreciated in the case of a controlled access device 204 being a software application or a website to which access is being controlled, being within range of the controlled access device 204 can be understood to mean within range of a computing device via which a user is attempting to execute the software or access the website.

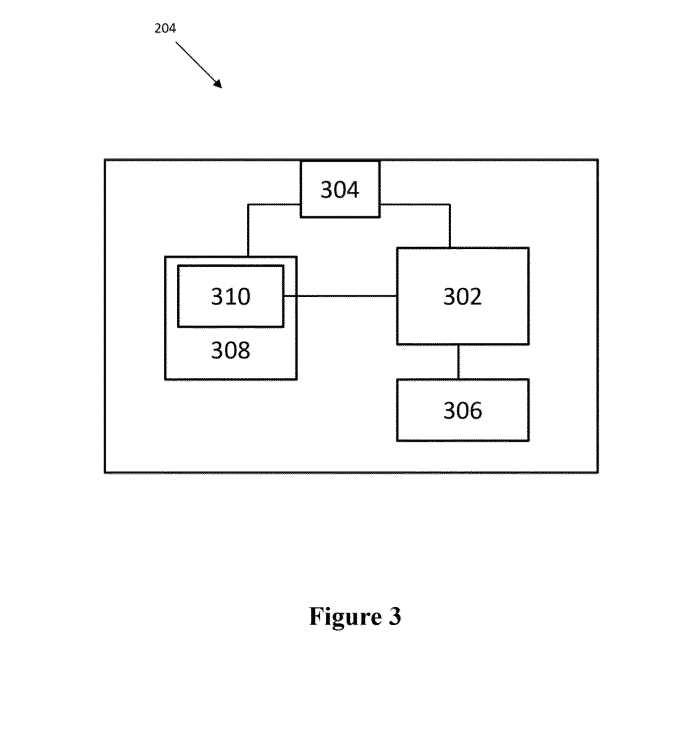

FIG. 3 illustrates an example block diagram of a controlled access device 204. The controlled access device 204 includes a locked device service 302 that interfaces with a communication interface 304 and listens for “I'm here” advertisements being broadcast by the key device 202, Ii should be appreciated that the communication interface 304 may be any suitable wired or wireless communication interface or combination of wired and wireless.

Locked device service 302 is configured to run continuously in the background without interfering with the normal operation of controlled access device 204. When the locked device service 302 detects an “I'm here” advertisement and the controlled access device 204 is in a “locked” state, the locked device service 302 examines internal memory 306 to identify a stored password associated with key device 202 from which the advertisement was received. If an associated. password is found, meaning that the key device 202 is authorized to unlock the controlled access device 204, the locked device service 302 will then Change the state of the controlled access device 204 to an “unlocked” state and grant access. The locked device service 302 continues to run in the background and listen for “I'm here” advertisements. The locked device service 302 will continue to maintain the controlled access device 204 in an “unlocked” state and grant access as long as the locked device service 302 continues to receive “I'm here” advertisements. If the locked device service 302 stops detecting “I'm here” advertisements, the locked device service 302 will change the state of the controlled access device 204 to a “locked” state and prevent access.

In one example, instead of examining internal memory 30(to identify a stored password associated with key device 202 from which the “I'm here” advertisement was received, the locked device service 302 communicates, via the communication interface 304, with the access server 206, as described in FIG. 1, to retrieve the associated password.

In one example, the controlled access device may include a web browser 308 for accessing websites via the Internet. In such a case, the locked, device service 302 may further control access to websites via the web browser 308. In particular, the controlled access 204 device further includes a web browser access plugin 310 for granting access to access controlled websites via the locked device service 302. The web browser access plugin 310 works in combination with the web browser 308 and automatically detects when the web browser 308 is used to access a password-protected website. When such a website is accessed, the web browser access plugin 310 checks with the locked device service 302 to determine whether the controlled access device 204 is in a “locked” state. If the controlled access device 204 is in a “locked” state, the web browser access plugin 310 does nothing further.

If web browser access plugin 310 determines that the controlled access device 204 is in an “unlocked” state, indicating that a key device 202 is within range, the web browser access plugin 310 requests, via the locked device service 302, a password for the website associated with the key device 202. The locked device service 302 then communicates with the access server 206 to retrieve a password associated with the key device for the website being accessed. If the locked device service 302 successfully identifies and retrieves a password, the locked. device service 302 provides the password to the web browser access plugin 310 and the web browser access plugin 310 automatically logs into the website and wants access to the user of the key device 202.

In one example, after logging in and granting access, the web browser access plugin 310 continues to monitor the state of the controlled access device 204 by communicating with the locked device service 302 to confirm that the controlled access device 204 is in an “unlocked” state. If at any point in time the web browser access plugin 310 determines, via the locked device service 302, that the controlled access device 204 is no longer in an “unlocked” state, the web browser access plugin 310 automatically logs out of the website to which access was granted.

It should be appreciated that the web browser access plugin 310 may communicate with the locked device service 302 at any suitable predetermined time interval. For example, the web browser access plugin 310 may be configured to check the status of the controlled access device 204 once every 10 seconds, once every 30 seconds, or once every minute.

If the locked device service 302 isn't able to successfully retrieve the password because a password associated with the particular key device 202 for the particular website hasn't previously been stored, the web browser access plugin 310 does nothing. In one example, the web browser access plugin 310 may automatically, upon determining that a password associated with the particular key device 202 for the particular website hasn't previously been stored, notifies the user that the website hasn't been previously access via the key device 202 and asks whether the user wishes to store a password for the website, in one example, the web browser access plugin 310 waits until a user enters a password manually before asking the user if the password should be stored for automatic login for future access, in one example, the web browser access plugin 310 automatically stores a manually entered password, without asking the user, for future automatic login via the key device 202.

In one example, the access server 206 maintains information about the ownership state of the key device 202. For example, the access server 206 maintains a status of either “Normal” or “Stolen” for a key device 202. For example, if a status of the key device 202 is “normal”, then the system 200 functions normally as expected and the access server 206 provides passwords as expected when requested by the locked device service 302 of the controlled access device 204. However, when a status of the key device 202 is “stolen”, then the access server 206 ignores password requests received from the locked device service 302 of the controlled access device 204 initiated as a result of the “stolen” key device 202 being within range of the controlled access device 204. A status of a key device 202 can be changed to “Stolen”, for example, by a systems administrator in response to being notified that the key device 202 has been stolen.

In one example, a locked device service 302 of a controlled, access device 204 may be configured to periodically poll the access server 206 to confirm that the status of key device 202 is “normal.” In the event that the status of the key device 202 has been changed to “stolen,” the access server 206 may respond to the poll and indicate the change in status. Thus, the locked device service 302 may be configured to store in internal memory 306 a status of the key device 202 and ignore the key device 202 having a “stolen” status without needing to initiate a request with the access server 206. In one example, the access server 206 is configured to send a push notification to a locked device service 302 of the controlled access device 204 when the ownership status of a key device 202 is changed.

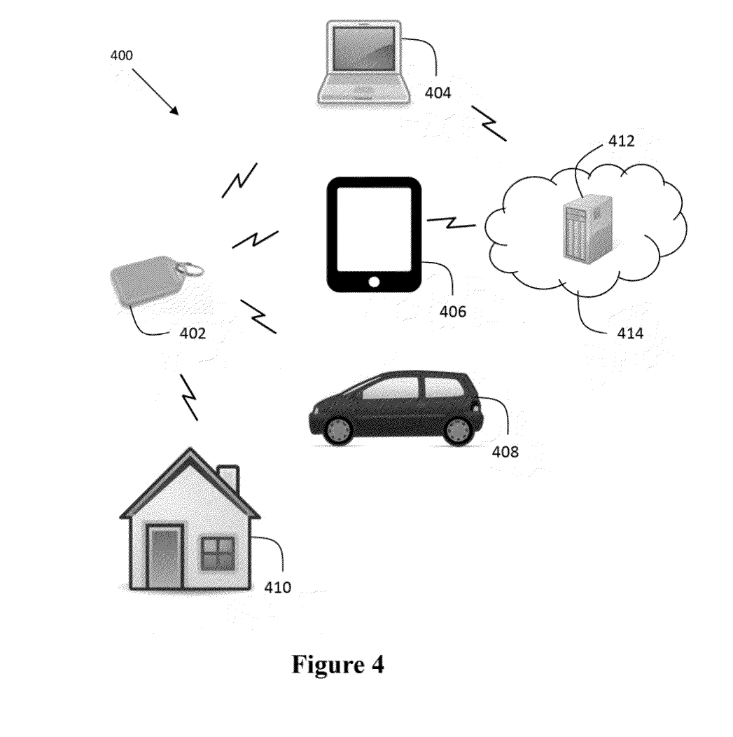

It should be appreciated that the “I'm here” advertisements being transmitted by a key device are one way broadcasts rather than direct one-to-one pairing communications. This enables the key device to be used for unlocking multiple devices simultaneously. In particular, any controlled access device that is within range and receiving the advertisements from the key device may be unlocked if the device has been configured to be unlocked automatically by that key device. FIG. 4 illustrates an example system 400 for enabling a key device 402 to unlock multiple controlled access devices simultaneously. For example, the key device 402 may be used to simultaneously unlock a laptop computer 404, a tablet computer 406, a car 408, and a home 410. It should be appreciated that although four example controlled access devices 404, 406, 408, and 410 are illustrated, the key device 402 may be configured to unlock any suitable number of controlled access devices simultaneously. In addition, the key device 402 may be configured to unlock any suitable number of controlled access devices independently, rather than simultaneously.

It should be appreciated that each controlled access device 404, 406, 408, and 410 includes a locked, device service (not shown) for managing the state of the controlled access device. Therefore, each one of the controlled access devices 404, 406, 408, and 410 can be either in a “locked” or “unlocked” state independent of the state of others.

The system 400 further includes an access server 412 in a cloud environment 414 for encrypting and storing passwords defined by a user of the key device 402 and associating the passwords with the key device 402 and the respective controlled access devices. It should be appreciated that not all passwords are stored at the access server 412. Rather, locked device services of controlled access devices with limited Internet connectivity may store passwords locally. For example, a locked device service of a home 410 or a car 408 may store a password locally while a locked device service of a tablet computer 406 or a laptop computer 404 may communicate with the access server 412 to obtain a password.

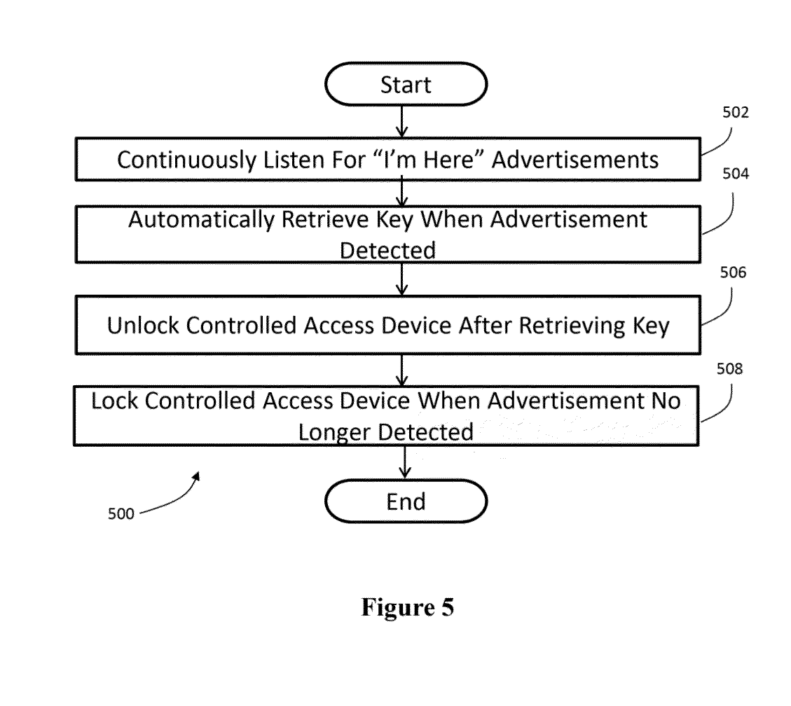

FIG. 5 is a flow diagram 500 illustrating exemplary interaction between a controlled access device 204, a key device 202, and an access server 206. At step 502, the controlled, access device 204 continuously listens for an “I'm here” advertisement from a key device 202, At step 504, when the controlled access device 204 detects the advertisement, the controlled access device 204 automatically attempts to retrieve a key or password to unlock the controlled access device 204. In one example, the controlled access device 204 retrieves the key from the access server 206. At step 506, upon successfully retrieving the key, the controlled access device 204 unlocks and grants access. The controlled access device 204 continues to maintain an unlocked state while it continues to detect “I'm here” advertisements being transmitted by the key device 202. At step 508, when the controlled access device 204 ceases to detect “I'm here” advertisements, the controlled access device 204 changes to a locked, state and access to the controlled access device 204 is blocked.

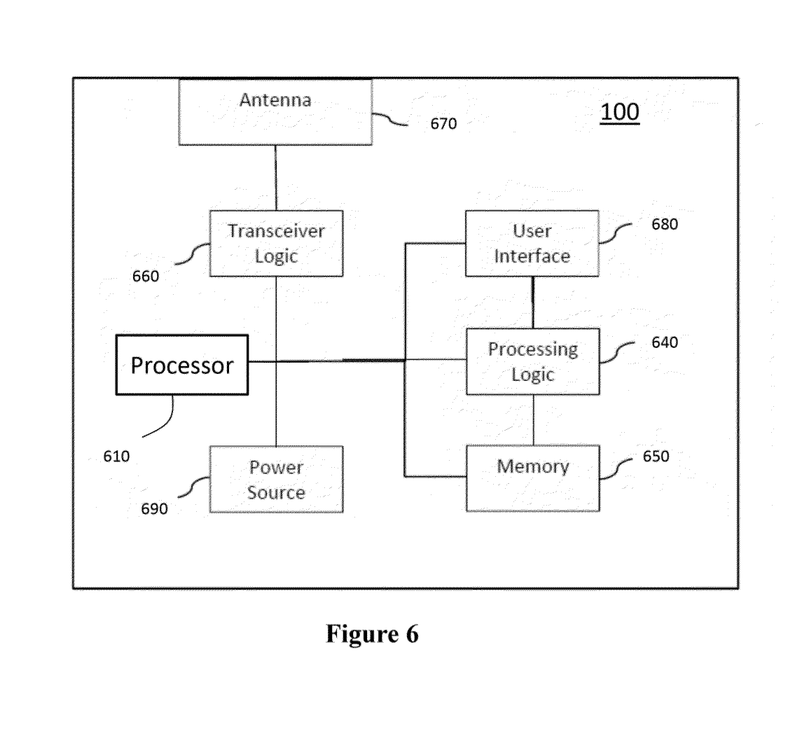

With reference now to FIG. 6, a block diagram illustrates exemplary components of an embodiment of a key device 100 of FIG. 1. Key device 100 includes processing logic 640 and a processor 610 to execute the processing logic 640 stored on a computer-readable medium. The processing logic 140 is configured to control clocking, authentication, and communication activities. Of course, these activities may be divided or allocated among other application specific logics. As further discussed below, processing logic 640 obtains data from a data store 650. From the stored data, processing logic 640 forms a message, preferably in the form of “unlock advertising” for transceiver logic 660 stored on a computer-readable medium, to broadcast via antenna 670. Processing logic 640 may optionally provide an indication to a user through a user interface 680 of communications generally or success or failure to access a controlled access device. The user interface 680 may be configured as a visual indicator such as an LED, an audible indication, a graphical indication or the like. The processor 610 may be powered front an internal power supply 690 such as a battery. The power supply 690 may be replaceable, rechargeable, or both.

In one embodiment, to preserve power supply 690, the processing logic 640 may be configured to place components of key device 100 in a standby or low power state and periodically “wake” needed components to perform needed activities such as authentication or communication.

In one embodiment, the key device 100 would be able to manage access for third-party controlled access devices 130 through software and hardware plug-ins. For example, software plug-ins may include a software development, kit (“SDK”) and/or an application programming interface (“API”) that could be used on a third-party controlled access device to communicate with the key device 600. Exemplary hardware plug-ins, which include a piece of hardware developed to communicate with the key device 100, could be connected to a third-party controlled access device 130 as a way to grant access to features of their device. The hardware plug-in would send a current to the third-party controlled access device 130 when communicating with key device 100 and would send no current when communication breaks.

For example, the hardware plug-in can authenticate with key device 100 and send an electrical signal to a wire or a pin when key device 100 is determined to be within a defined. range. If the key device 100 is not within range, the plug-in would not send any signals to the pin. A third party controlled access device 130 interfaces with the hardware plug-in by connecting to the pin or wire. The third party controlled access device 130 is configured to unlock when an electrical signal is detected on the wire or pin and to lock. when no electrical signal is detected. The reverse of this behavior could also occur if specified by the third party. The communication would follow the schema of the algorithm described below.

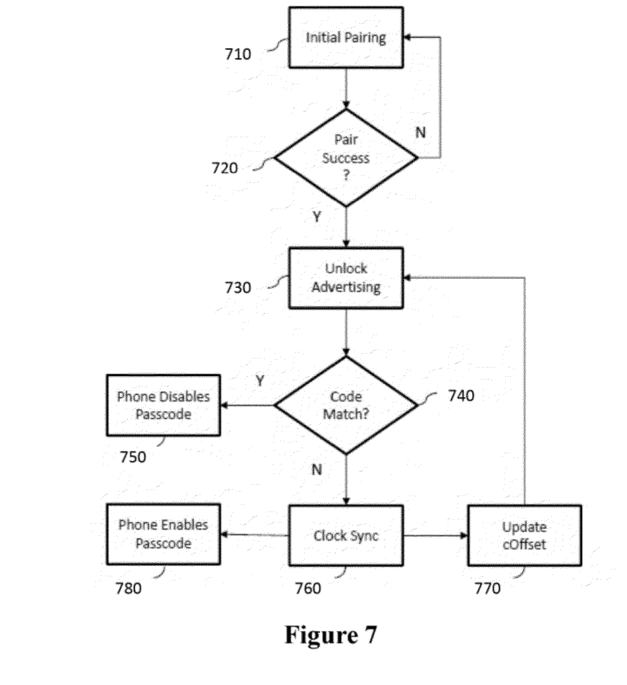

With reference now to FIG. 7, an example flow diagram of the interactions between a key device 100 and a controlled access device 130 is described. Initially, a key device 100 and a controlled access device 130 will pair 310 upon an initial encounter or after pairing data is lost between the two. The initial pairing 710 may include a user entering a code into an application or data entry field on the controlled access device 130. The controlled access device 130 may store the code in a computer-readable medium and calculate a key from the code using a formula. The controlled access device 130 may also store the calculated key. An initial pairing may additionally include a clock synchronization as described more fully below. Initial pairing is complete upon successful synchronization (if needed) and a matching code exchanged from the key device 100 to the controlled access device 130. Alternately, the initial pairing may include a. code match from the controlled access device 130 to the key device 100 as well as a code match from the key device 100 to the controlled access device 130.

Upon successfully validating a request and pairing 720 with the controlled access device 130, the key device 100 will then periodically “advertise” its presence by broadcasting or advertising the code 730. When the controlled access device 130 receives the broadcast code, it may compare the received code to a stored code 740. The stored code may actually include several codes, for example, codes for a current time as well as codes for neighboring times, where neighboring times include those a few seconds to a few minutes on either side of current device time. If the received code matches the stored code, the controlled access device 130 disables its password or other access control and grants access 750. If the received code does not match the stored code, one problem may be that the respective clocks have drifted or been set too far apart. To check, the controlled access device 130 may synchronize 760 its clock with the clock of the key device 100. The clock synchronization may be accomplished by the controlled access device 130 generating a random number, encrypting the random number and sending it to the key device 100. The key device 100 may decrypt the random number and return it encrypted with clock data. The controlled access device 130 decrypts the number and clock data and checks the random number for continuity. If the random number correctly decrypts and matches the generated number, the device may update its offset based on the received clock data 770. Thereafter, the codes should match enabling access to the controlled access device 130. If the random number is not correctly decrypted, authentication fails and the controlled access device 130 ensures its password or other access controls are maintained or restored 780 and, therefore, the controlled access device 130 remains locked.

In operation and under normal conditions, the key device 100 and the controlled access device 130 operate without two-way communication. For example, once initial pairing is complete, whenever the key device 100 and controlled access device 130 are within signal proximity, the controlled access device 130 receives periodic unlock advertising from the key device 100, authenticates the code, and overrides or bypasses its password or access controls. The controlled access device 130 may permit continued use while continuing to receive the periodic advertising and may restore its access controls when the advertising is not received for a time.

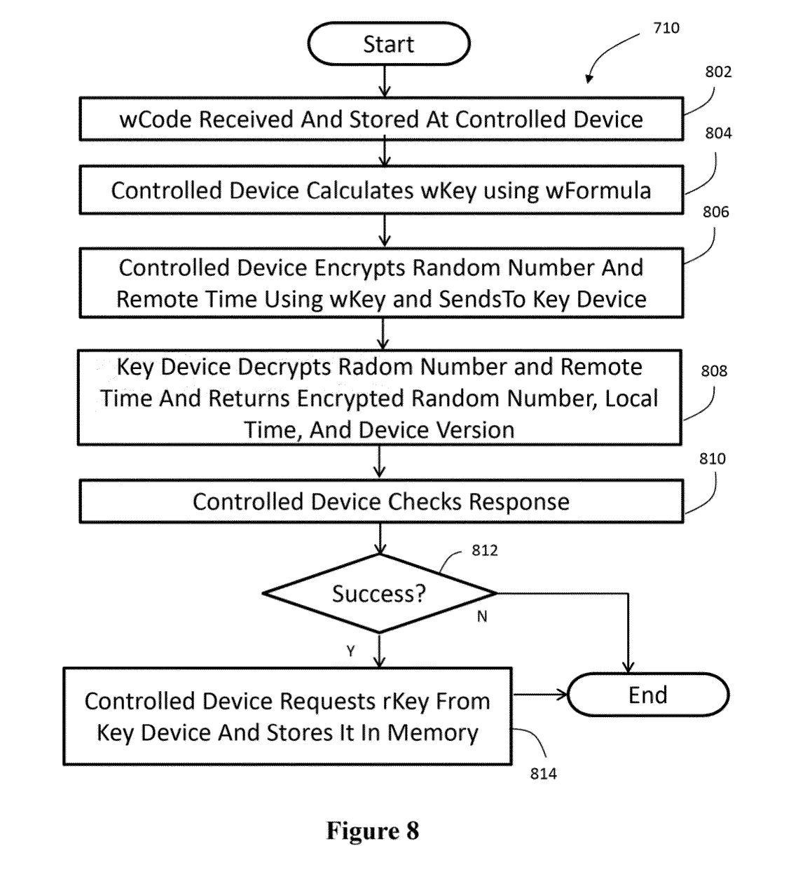

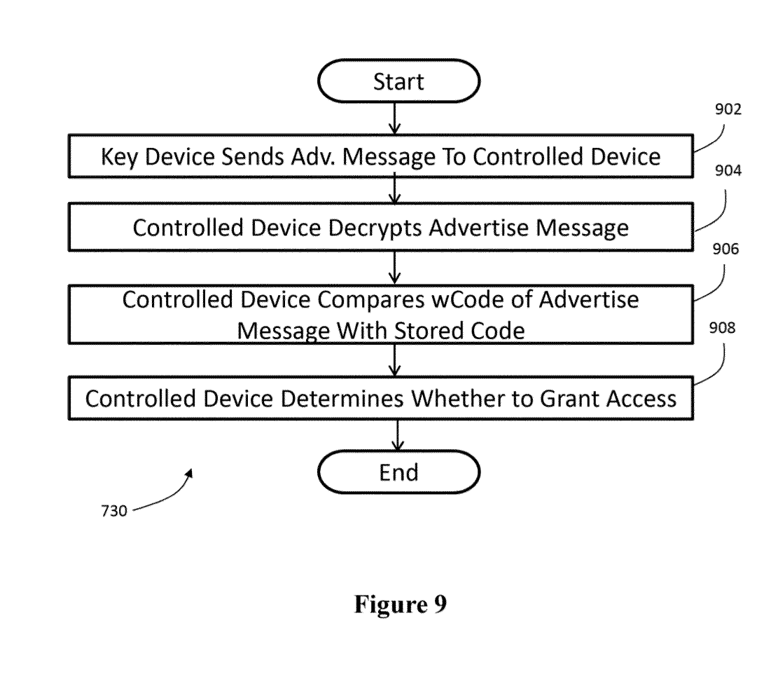

With reference now to FIGS. 8-9, variables “wCode”, “wKey”, “rKey”, “storedTime”, “Local Time”, “Remote Time”, “AdvMsg”, “cOffset”, “actOffset”, and “wFormula” are introduced and are used as follows. “wCode” is deemed to include a code, for example, a code printed on the wristband or key device. “wKey” is defined, as a symmetric encryption key generated by “wFormula.” “rKey” is defined as a syymnetric encryption key stored in memory of key device. “storedTime” is defined as the Local Time stored in memory of the key device. “Local Time” is defined as the actual date and time on the local device, either at the key device or the controlled access device. “Remote Time” is defined as the actual date and time on a device remote to the local device, which can be either the key device or the controlled access device. “AdvMsg”, or Advertising Message is defined as “wCode” and key device “Local Time” encrypted with “rKey”, “cOffset”, or Expected Clock Offset, is defined as the expected offset between the key device clock and controlled access device clock. “actOffset”, or Actual Clock Offset, is defined as the actual offset between the key device clock and controlled access device clock. “wformula” is a formula that generates “wKey” from “wCode”.

With reference now to FIG. 8, an example flow diagram of the steps of the initial pairing 710 between key device 100 and a controlled access device 130 is described. A user first obtains a wCode printed on, obtained from or otherwise provided with, the key device 100 and provides the wCode to the controlled access device 130, 802. This can include entering the wCode into a software application being executed by the controlled access device 130, for example. The controlled access device 130 stores the wCode in memory. The controlled access device 130 then uses the stored wCode to generate or calculate a wKey using wFormula and stores the wKey in memory 804.

The controlled access device 139 then generates a random number and encrypts the random number, along with actual Local Time at the controlled access device 103, using the stored wKey and communicates the encrypted data to the key device 100, 806. The key device 100 decrypts the random number and the Remote Time, or the time at the controlled access device 103, 808. The key device 100 then encrypts the random number along with the Local time at the key device 100 and with a device version number, using, the wKey, and responds by communicating the encrypted data back to controlled access device 130, 808.

The controlled access device 130 then decrypts and checks the response 810. In particular, controlled access device 130 checks the random number and compares it to the initially sent random number. If it doesn't match, the controlled access device 130 notifies the user that the pairing has failed. Otherwise, the controlled access device 130 updates cOffset by determining the difference between the Remote Time, or the Local Time at the key device 100, and the Local Time at the controlled access device 130. The controlled access device 130 also checks device version to confirm that key device 100 is supported. Checking the version may include comparing the version number to a list of supported version numbers, for example. If the controlled access device 130 determines that the version number is not supported, the user is notified that the pairing failed. Otherwise, controlled access device 130 stores the version number.

If the controlled access device 130 determines that the key device 100 successfully responded 812 meaning that the key device 100 returned a correct random number and that the version number of the key device 100 is supported, then the controlled access device 130 proceeds to request an rKey from key device 100, 814. The key device 130 encrypts the rKey using wKey and responds to the request, after which the controlled access device 130 decrypts and stores the rKey in memory 814.

The controlled access device 130 then sends a message to key device 100 confirming successful pairing. In one example, a clock synchronization, as described above, is performed after an initial pairing, if needed. Once pairing is complete, key device 100 may begin to advertise or broadcast a code to controlled access device 130.

With reference now to FIG. 9, an example flow diagram of the steps of the unlock advertising 730 between key device 100 and a controlled, access device 130 is described. In one example, unlock advertising 730 occurs once every second but it should be appreciated that any suitable time interval may be used. The key device 100 first generates AdvMsg by encrypting wCode and Local Time at the key device 100 using the rKey and sends the AdvMsg to the controlled access device 130, 902. The controlled access device 130 receives and decrypts the AdvMsg 904. The secured access device 130 then compares the wCode received in the AdvMsg with a stored wCode 906. Based on the comparison, the controlled access device 130 then determines whether to grant access 908. In particular, if the wCode in the received AdvMsg does not match the stored wCode, the controlled access device 130 is locked and access is not granted. If the codes do match, an actOffset is calculated using Local Time at the controlled access device 130 and the Remote Time, or the received Local Time at the key device 100. If the difference between actOffset and the stored cOffset is less than a predetermined value such as three (3) seconds, for example, the controlled access device 130 is unlocked and access is granted. But if the difference between the actOffset and the stored cOffset is greater than or equal to the predetermined value, a clock synchronization is performed, as already described.

It should be appreciated that example system and method described can be applied for granting access to multiple devices simultaneously. In particular, upon receiving a valid AdvMsg, the controlled access device 130 grants access and does not respond to the key device 100. This method allows an unlimited number of controlled access devices 130 to receive the same AdvMsg and grant access simultaneously.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

As used herein, “connection,” “connected,” or “connectable” means both directly, that is, without other intervening elements or components, and indirectly, that is, with another component or components arranged between the items identified or described as being connected. To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See, Bryan A. Garner, A Dictionary of Modern Legal Usage 624 (2d. Ed. 1995).

What is claimed:

1. A controlled access device comprising at least one processor, at least one computer readable medium, and program instructions stored on the at least one computer readable medium for execution by the processor, the program instructions comprising:
first program instructions to continuously listen for advertisement data being broadcast by a lock device, the advertisement data indicative of the lock device being within a predefined range of the controlled access device;
second program instructions to automatically retrieve a key for granting access to the controlled access device responsive to the first program instructions detecting the advertisement data while the controlled access device is in a locked state;
third program instructions to unlock the controlled access device and grant access to the controlled, access device responsive to the second program instructions retrieving the key; and
fourth program instructions to lock the controlled, access device and deny access to the controlled access device responsive to the first program instructions ceasing to detect the advertisement data while the controlled access device is an unlocked state.

2. The controlled access device of claim 1, wherein the program instructions further comprise fifth program instructions for pairing the lock device with the controlled access device.

3. The controlled access device of claim 2, wherein the second program instructions are configured to automatically retrieve the key responsive to determining that the controlled access device has been paired with the key device.

4. The controlled access device of claim 1, wherein the second program instructions are configured to automatically retrieve the key from a remote computing device.

5. The controlled. access device of claim 4, wherein the remote computing device is accessible by a plurality of controlled access devices.

6. The controlled access device of claim 1, wherein the second program instructions are configured to automatically retrieve the key from memory internal to the controlled access device.

7. The controlled access device of claim 1, wherein the program instructions further comprise sixth program instructions to periodically poll a remote computing device, configured to store the status of the key device, to determine the status of the key device, and wherein the first program instructions are configured to ignore the key device if status of the key device is determined to be one of lost or stolen.

8. The controlled access device of claim 1, wherein the program instructions further comprise seventh program instructions to receive a push notification indicative of the key device being one of lost or stolen, and wherein the first program instructions are configured to ignore the key device responsive to the seventh program instructions receiving the push notification.

9. An access control method, the method comprising the steps of:
listening for advertisement data being broadcast by a lock device, the advertisement data indicative of the lock device being within a predefined range of a controlled access device;
automatically retrieving a key for granting access to the controlled access device responsive to detecting the advertisement data while the controlled access device is in a locked state;
unlocking the controlled access device and granting access to the controlled access device responsive to retrieving the key; and
locking the controlled access device and denying access to the controlled access device responsive to ceasing to detect the advertisement data while the controlled access device is in an unlocked state.

10. The access control method of claim 9, further comprising the step of pairing the controlled access device with the lock device.

11. The access control method of claim 10, wherein the step of automatically retrieving the key comprises automatically retrieving the key responsive to determining that the controlled access device has been paired with the key device.

12. The access control method of claim 9, wherein the step of automatically retrieving a key comprises automatically retrieving the key from a remote computing device.

13. The access control method of claim 12, wherein the remote computing device is accessible by a plurality of controlled access devices.

14. The access control method of claim 9, wherein the step of automatically retrieving, a key comprises automatically retrieving the key from memory internal to the controlled access device.

15. The access control method of claim 9, further comprising the step of polling a remote computing device, configured to store the status of the key device, to determine the status of the key device, and instructing the controlled access device to ignore the key device responsive to determining that the status of the key device is one of lost or stolen.

16. The access control method of claim 9, further comprising the step of receiving a push notification indicative of the key device being one of lost or stolen and instructing the controlled access device to ignore the key device responsive to receiving the push notification.

17. An access server for controlling simultaneous access to a plurality of controlled access devices via a paired lock device, the access server comprising at least one processor, at least one computer readable medium, and program instructions stored on the at least one computer-readable medium for execution by the processor, the program instructions comprising:
first program instructions to receive, from a plurality of controlled access devices, requests for keys for unlocking the respective plurality of controlled access devices responsive to the plurality of controlled access devices detecting an advertisement being broadcast by the lock device indicative of the lock device being within a predefine range of the plurality of controlled access devices;
second program instructions to communicate keys to the respective controlled access devices responsive to determining that the respective controlled access devices have been paired with the lock device.

18. The access server of claim 17, wherein the program instructions further comprise third program instructions to receive data indicative of the key device being one of lost or stolen, and wherein the second program instructions are configured to ignore the requests for keys from the plurality of controlled access devices responsive to the plurality of controlled access devices detecting the advertisement being broadcast by the lock device determined to be one of lost or stolen.

19. The access server of claim 18, wherein the program instructions further comprise fourth program instructions to send a push notification, indicative of the lock device being one of lost or stolen, to the plurality of controlled access devices paired with the lock device responsive to the third program instructions receiving data indicative of the lock device being one of lost or stolen.

20. The access server of claim 17, wherein the program instructions further comprise fifth program instructions for receiving and storing data representative of the pairings between the plurality of controlled access devices and the key device.
